(19) United States
(12) Patent Application Publication
(10) Pub. No.: US 2016/0230698 A1
(43) Pub. Date: Aug. 11, 2016

(54) THERMAL SPRAYING APPARATUS AND THERMAL SPRAYING METHOD

(71) Applicant: TOYOTA JIDOSHA KABUSHIKI KAISHA, Toyota-shi (JP)

(72) Inventors: Takuzo HIRANO, Toyota-shi (JP); Atsuyoshi TATSUMI, Chiryu-shi (JP); Yushi TAKEUCHI, Nagakute-shi (JP)

(73) Assignee: TOYOTA JIDOSHA KABUSHIKI KAISHA, Toyota-shi (JP)

(21) Appl. No.: 15/017,366

(22) Filed: Feb. 5, 2016

(30) Foreign Application Priority Data
Feb. 6, 2015 (JP) 2015-022284

(51) Int. Cl. F02F 7/00; F02F 1/00; B05B 15/04; C23C 4/00; B05B 7/16

(52) U.S. Cl. CPC F02F 7/0095; C23C 4/00; B05B 7/16; B05B 15/0431; F02F 1/004

(57) ABSTRACT

A thermal spraying apparatus and a thermal spraying method capable of preventing thermal spray droplets from adhering to a cylinder bore. A thermal spraying apparatus according to an exemplary embodiment includes a thermal spraying gun that sprays a thermal spray material on an internal wall surface of a cylinder bore of a cylinder block, and a gas blowing jig inserted into the inside of an adjacent cylinder bore adjacent to the cylinder bore, blowing openings being formed in the gas blowing jig, the blowing openings being configured so that a gas is blown therefrom and flows downward from the top of the adjacent cylinder bore throughout the entire inner wall surface thereof.

### INCORPORATION BY REFERENCE

This application is based upon and claims the benefit of priority from Japanese patent application No. 2015-22284, filed on Feb. 6, 2015, the disclosure of which is incorporated herein in its entirety by reference.

### BACKGROUND OF THE DISCLOSURE

1. Field of the Disclosure

The present disclosure related to a thermal spraying apparatus and a thermal spraying method.

2. Description of Related Art

Japanese Unexamined Patent Application Publication No. 2006-233960 discloses a thermal spraying masking method for a cylinder block for a V-engine. In the method disclosed in Japanese Unexamined Patent Application Publication No. 2006-233960, a thermal spraying gun is inserted in a cylinder bore in one of the cylinder banks and an air curtain gun is inserted in a cylinder bore in the other cylinder bank. Further, the air curtain gun blows air during the thermal spraying process performed by the thermal spraying gun. This prevents any of the thermal spray material from adhering to other cylinder bores through a connecting part (crankcase) between the cylinders.

In the thermal spraying masking method disclosed in Japanese Unexamined Patent Application Publication No. 2006-233960, the air flows only on the periphery of the connecting part, Therefore, there is a gap, Where no air flows, between the bore and the jig, causing dragging of air into an adjacent cylinder bore(s), There is a possibility that thermal spray droplets such as soot and sputtered substances could adhere to the inside of an adjacent cylinder bore(s) due to this dragging of air. Further, in the case of a type of an aluminum cylinder block in which cylinders are arranged in a line, there are cases in which a connecting hole called “breathing hole” for connecting cylinders to each other is formed in order to prevent the formation of blow holes (or cavities) in the die casting process. When thermal spraying is performed for a bore surface after the die casting process, thermal spray droplets scatter from the cylinder bore where the thermal spraying is performed to an adjacent cylinder bore(s) through this breathing hole.

In the related-art air curtain, thermal spray droplets could possibly adhere to a cylinder bore due to the dragging of air. It is conceivable to insert a tubular or cylindrical jig into a cylinder bore to prevent thermal spray droplets from adhering to the surface of an adjacent cylinder bore, and thereby prevent any thermal spray droplets from entering the adjacent cylinder bore through the breathing hole. However, it would still be impossible to prevent thermal spray droplets from adhering to apart of the jig that is opposed to the breathing hole. Therefore, it is necessary to remove the thermal spray droplets adhered to the jig each time the thermal spraying task is finished before starting the next task, leading to unsatisfactory productivity.

The present disclosure has been made in view of the above-described problem and can effectively prevent thermal spray droplets from adhering to an adjacent cylinder bore(s).

### BRIEF SUMMARY

A thermal spraying apparatus according to an aspect of the present disclosure includes: a thermal spraying gun that sprays a thermal spray material on an inner wall surface of a cylinder bore of a cylinder block; and a gas blowing jig inserted into the inside of an adjacent cylinder bore adjacent to the cylinder bore, blowing openings being formed in the gas blowing jig, the blowing openings being configured so that a gas is blown therefrom and flows downward from the top of the adjacent cylinder bore throughout the entire inner wall surface thereof. This configuration can effectively prevent thermal spray droplets from adhering to the adjacent cylinder bore or the gas blowing jig.

In the above-described thermal spraying apparatus, a plurality of blowing openings may be formed in the gas blowing jig. This can make the gas flow more appropriately.

In the above-described thermal spraying apparatus, a plurality of blowing openings may be arranged with intervals therebetween along an outer circumferential surface of the gas blowing jig, the outer circumferential surface being opposed to the inner wall surface of the adjacent cylinder bore. This can make the gas flow more appropriately.

In the above-described thermal spraying apparatus, the gas blowing jig may include a lid that covers a top surface of the adjacent cylinder bore. This can make the gas flow more appropriately.

A thermal spraying method according to an aspect of the present disclosure includes: a step of inserting a thermal spraying gun into a cylinder bore of a cylinder block and inserting a gas blowing jig into the inside of an adjacent cylinder bore adjacent to the cylinder bore; and a step of spraying a thermal spray material on an inner wall surface of the cylinder bore by the thermal spraying gun while blowing a gas by the gas blowing jig no that the gas flows downward from the top of the adjacent cylinder bore throughout the entire inner wall surface thereof. This configuration can effectively prevent thermal spray droplets from adhering to the adjacent cylinder bore.

In the above-described thermal spraying method, a plurality of blowing openings may be formed in the gas blowing jig. This can make the gas flow more appropriately.

In the above-described thermal spraying method, a plurality of blowing openings may be arranged with intervals therebetween along an outer circumferential surface of the gas blowing jig, the outer circumferential surface being opposed to the inner wall surface of the adjacent cylinder bore. This can make the gas flow more appropriately.

In the above-described thermal spraying method, the gas blowing jig may include a lid that covers a top surface of the adjacent cylinder bore. This can make the gas flow more appropriately.

According to the present disclosure, it is possible to provide a thermal spraying apparatus and a thermal spraying method capable of effectively preventing thermal spray droplets from adhering to an adjacent cylinder bore(s).

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF THE DRAWINGS

FIG. 1 schematically shows a structure of a cylinder block for which thermal spraying is performed;

FIG. 2 is across section schematically showing an internal structure of a cylinder block;

FIG. 3 schematically shows a state in which a thermal spraying gun and a gas blowing jig are inserted in cylinder bores;

FIG. 4 schematically shows a state in which thermal spraying is performed by a thermal spraying apparatus according to an exemplary embodiment;

FIG. 5 is a perspective view showing a structure of a gas blowing jig of a thermal spraying apparatus according to an exemplary embodiment;

FIG. 6 shows an arrangement of blowing openings of a gas blowing jig;

FIG. 7 shows a state in which a gas blowing of a thermal spraying apparatus according to an exemplary embodiment is inserted into a cylinder bore;

FIG. 8 shows a modified example 1 for an arrangement of blowing openings;

FIG. 9 shows a modified example 2 for an arrangement of blowing openings; and

FIG. 10 shows a modified example 3 for an arrangement of blowing openings.

### DESCRIPTION OF THE EXEMPLARY EMBODIMENTS

Exemplary embodiments of a thermal spraying apparatus and a thermal spraying method for a cylinder bore according to the present disclosure are explained hereinafter in detail with reference to the drawings. However, the present disclosure is not limited to the below-shown exemplary embodiments. Further, the following description and the drawings are simplified as appropriate for clarifying the explanation. The same symbols indicate substantially the same structures throughout the drawings.

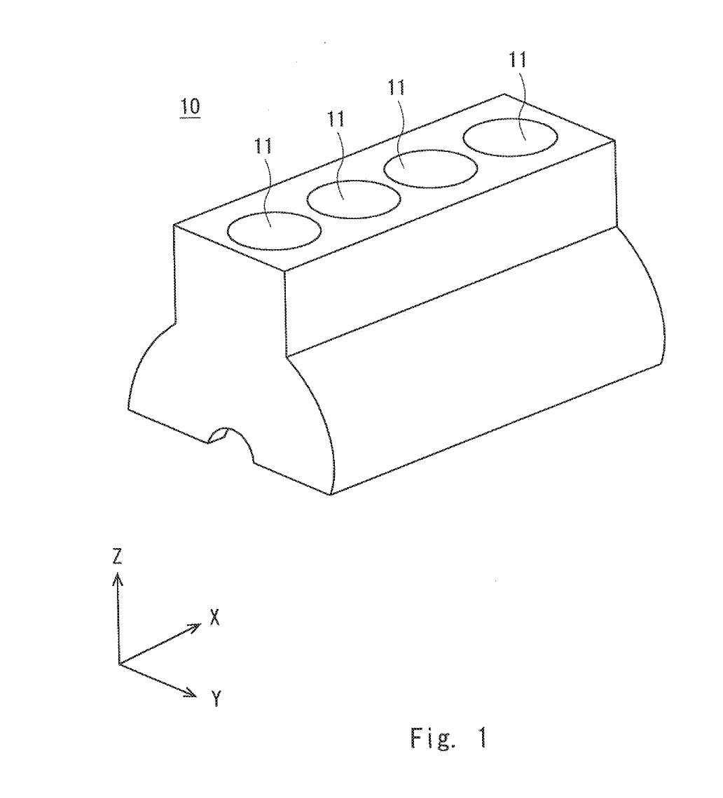

FIG. 1 is a perspective view schematically showing an example of a structure of an inline four-cylinder type cylinder block for an automobile engine. Note that an XYZ-three dimensional coordinate system is shown in FIG. 1 for clarifying the explanation. The Z-direction is the longitudinal direction of each cylinder bore (vertical direction) and the X-direction is a direction in which a plurality of cylinder bores are arranged (transverse direction). The Y-direction is the front/rear direction perpendicular to the X- and Z-directions. Note that the bottom side in FIG. 1 is the crankcase side.

As shown in FIG. 1, four cylinder bores 11 are formed in a cylinder block 10. Each of the cylinder bores 11 has a cylindrical shape and they are arranged in a row. In this exemplary embodiment, thermal spraying processes are successively performed for the inner wall surfaces of the cylinder bores 11 (e.g., the cylinder bores 11 are processed one by one, or two cylinder bores 11 that are located with one cylinder bore interposed therebetween are simultaneously processed). Note that although four cylinders are arranged in the X-direction 1, the arrangement and the number of cylinder bores 11 are not limited to the configuration shown in FIG. 1. Further, the cylinder block is not limited to the inline-type cylinder block in which cylinder bores 11 are arranged in a row. That is, the present disclosure may be applied to a V-type cylinder block.

The cylinder block 10 is formed by, for example, an aluminum die casting method. Then, a metal such as an iron powder is thermally-sprayed on the inner wail surfaces of the cylinder bores 11 of the cylinder block 10. This metal thermal spraying can make the bore surface thinner compared to the related art where an FC (Cast Iron) liner is casted inside the cylinder bore 11. Therefore, it can contribute to a reduction in weight and an improvement in fuel efficiency.

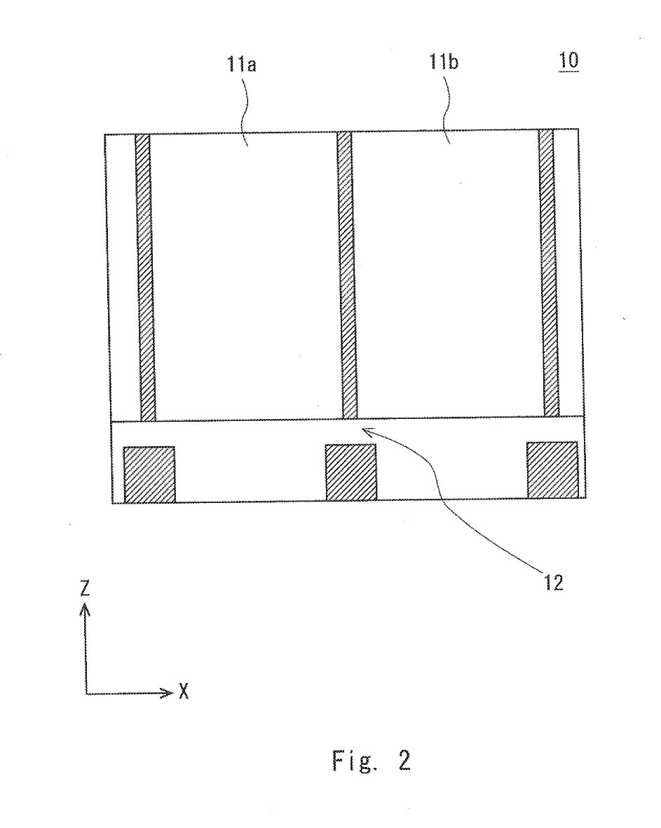

FIG. 2 shows a cross-sectional structure of the cylinder block 10. FIG. 2 is an XZ-cross section of the cylinder block 10 schematically showing a part of the structure of the cylinder block 10. In FIG. 2, two neighboring cylinder bores 11 are shown. In FIG. 2, of the two cylinder bores 11, the one located on the negative side in the X-direction is represented as “a cylinder bore 11a” and the other one located on the positive side is represented as “an adjacent cylinder bore 11b”.

The cylinder bore 11a and the adjacent cylinder bore 11b are arranged in parallel to each other. A breathing hole 12 is formed between the cylinder bore 11a and the adjacent cylinder bore 11b. Since the breathing hole 12 is formed in the cylinder block 10, the cylinder bore 11a and the adjacent cylinder bore 11b are connected to each other. The breathing hole 12 is formed under the cylinder bore 11a and the adjacent cylinder bore 11b. The breathing hole 12 is formed to prevent the formation of blow holes (or cavities) in the crude material in the case where a die casting method is used to manufacture the cylinder block 10.

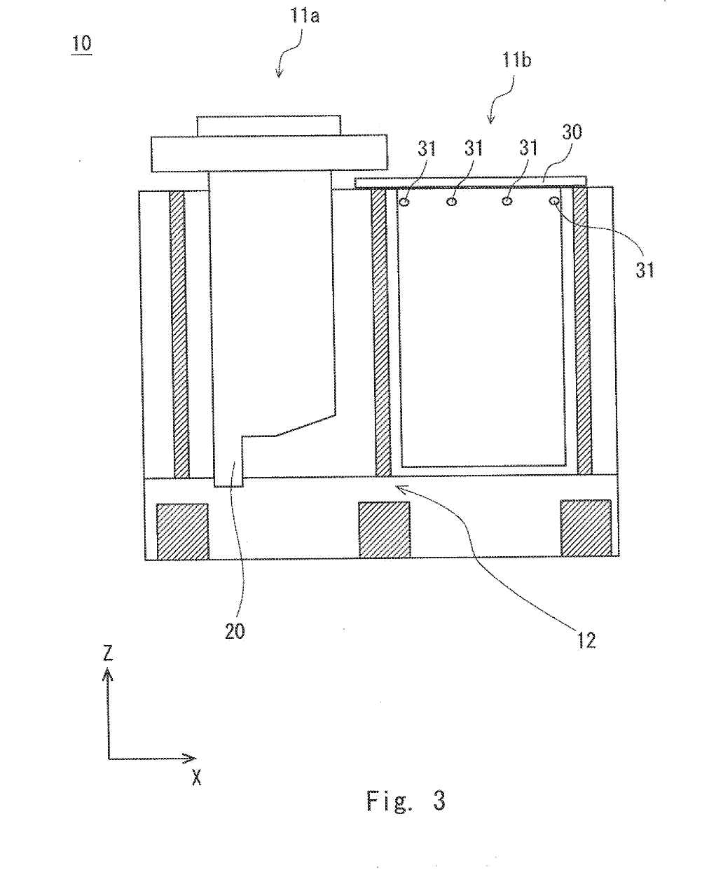

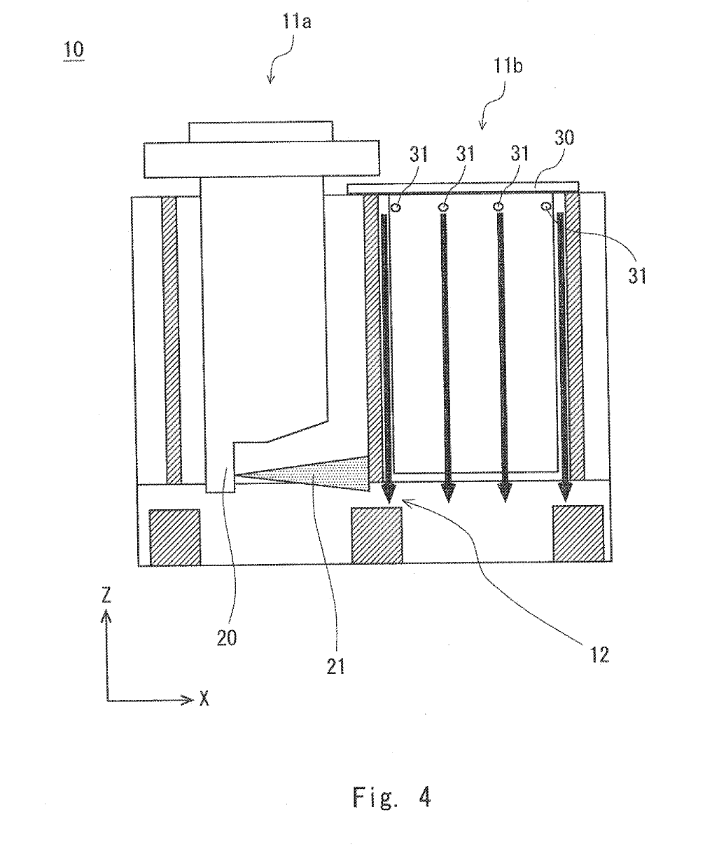

A process for thermally-spraying a thermal spray material on the cylinder bore 11a is explained with reference to FIGS. 3 and 4. As shown in FIG. 3, a thermal spraying gun 20 is inserted into the cylinder bore 11a for which the thermal spraying is performed. Further, a gas blowing jig 30 is inserted into the inside of the adjacent cylinder bore 11b. The gas blowing jig 30 has a cylindrical shape. Therefore, the outer circumferential surface of the gas blowing jig 30 is opposed to the inner circumferential surface of the adjacent cylinder bore 11b with a gap formed therebetween. Blowing openings 31 for blowing air are formed on the outer circumferential surface of the gas blowing jig 30. The blowing openings 31 are disposed at the top of the adjacent cylinder bore 11b. Note that the structure of the gas blowing jig 30 is described later.

Next, as shown in FIG. 4, air is blown from the blowing openings 31. By doing so, an air shield is formed near the inner wall surface of the adjacent cylinder bore 11b as indicated by arrows in FIG. 4. A gas is blown from the blowing openings 31 so that the gas flows downward from the top of the adjacent cylinder bore 11b throughout the entire inner wall surface thereof. The air shield indicated by the arrows is formed inside the adjacent cylinder bore 11b. That is, the gas flows downward from the top of the adjacent cylinder bore 11b in the gap space between the outer circumferential surface of the gas blowing jig 30 and the inner circumferential surface of the adjacent cylinder bore 11b. This gap space needs to have such dimensions that the air flows at an appropriate speed and no dragging of air occurs. Alternatively, the amount of the air to be blown as well as its speed needs to be adjusted. Then, the thermal spraying gun 20 sprays a thermal spray material 21 toward the inner wall surface of the cylinder bore 11a while the air shield is formed. The thermal spraying gun 20 sprays the thermal spray material 21 toward the inner wall surface of the cylinder bore 11a while the gas blowing jig 30 blows a gas so that the gas flows downward from the top of the adjacent cylinder bore 11b throughout the entire inner wall surface of thereof. The thermal spraying gun 20 sprays the thermal spray material 21 while, for example, melting iron wire using an arc discharge. In this way, the thermal spray material 21 is sprayed toward the cylinder bore 11a.

A thermally-sprayed film is formed on the inner wall surface of the cylinder bore 11a. During the thermal spraying process, the air shield is formed in the gap space in the adjacent cylinder bore 11b. This can prevent thermal spray droplets (soot and sputtered substances) from adhering to the inner wall surface of the adjacent cylinder bore 11b through the breathing hole 12. As described above, the thermal spraying apparatus according to this exemplary embodiment can prevent thermal spray droplets from adhering to the adjacent cylinder bore 11b for which no thermal spraying has been performed yet. By preventing the adhesion of thermal spray droplets, which is one of the causes for the adhesive strength of the thermally-sprayed film being lowered, the peeling of the thermally-sprayed film can be prevented. Further, the adhesion of thermal spray droplets to the jig itself is also prevented or reduced. That is, since the air shield can be formed toward the crankcase side without leaving any unshielded space, the dragging of thermal spray droplets can be prevented. Therefore, it is possible to prevent thermal spray droplets from adhering to the inner wall surface of the adjacent cylinder bore 11b or the surface of the gas blowing jig 30 through the breathing hole 12.

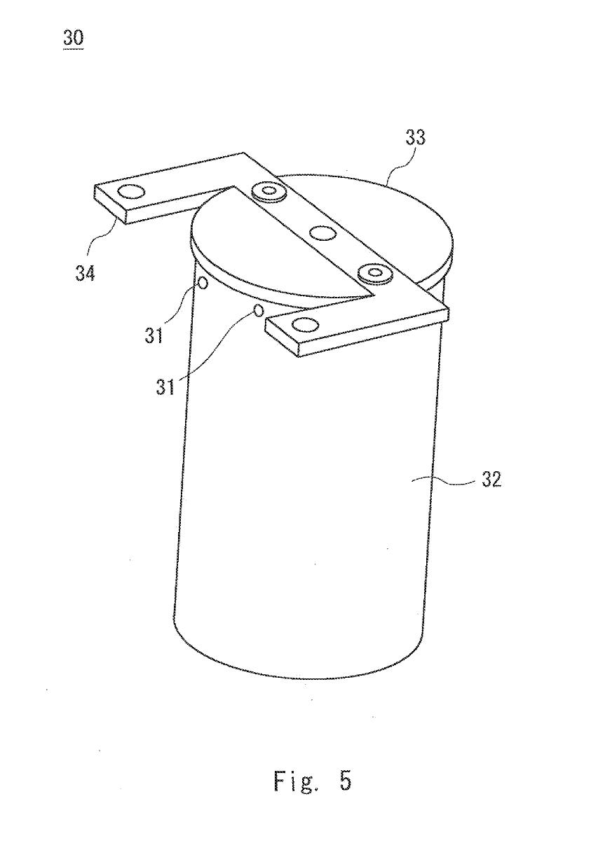

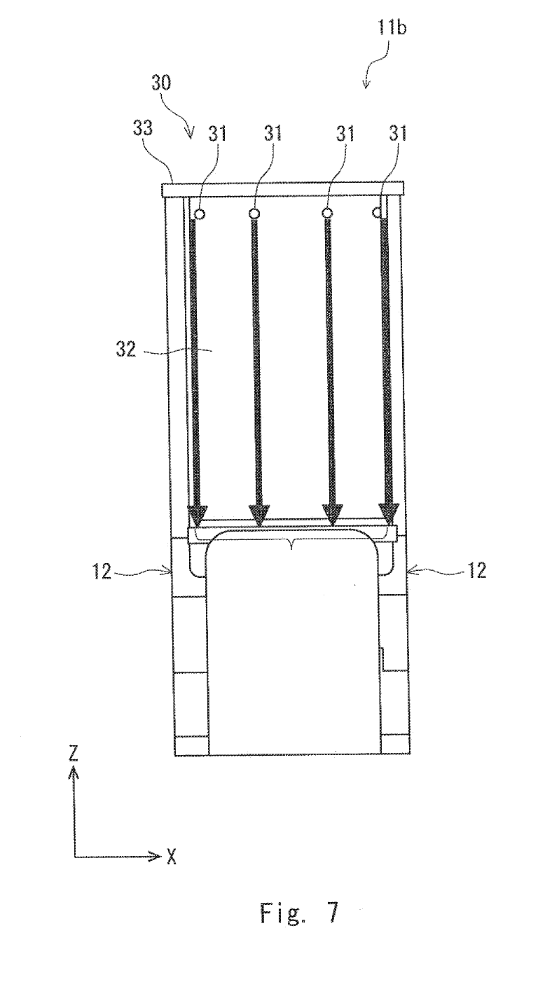

Next, a structure of the gas blowing jig 30 is explained with reference to FIGS. 5 to 7. FIG. 5 is a perspective view schematically showing a structure of the gas blowing jig 30. 6 is an XY-cross section schematically showing the structure of the gas blowing jig 30. FIG. 7 is a side view schematically showing the gas blowing jig 30 inserted into the adjacent cylinder bore 11b.

As shown in FIG. 5, the gas blowing jig 30 includes a main body 32, a lid 33, and a holding part 34. The main body 32 is a cylindrical member and has a space formed in its inside into which a gas is supplied. The diameter of the main body 32 is slightly smaller than the inner diameter of the adjacent cylinder bore 11b so that it can be inserted into the adjacent cylinder bore 11b. For example, when the gas blowing jig 30 is inserted into the adjacent cylinder bore 11b, a gap of several millimeters is formed between the outer circumferential surface of the main body 32 and the inner wall surface of the adjacent cylinder bore 11b.

The lid 33 is formed on the top end of the main body 32. The lid 33 has a disk shape and protrudes from the main body 32. The diameter of the lid 33 is larger than the diameter of the adjacent cylinder bore 11b. Therefore, when the gas blowing jig 30 is inserted into the adjacent cylinder bore 11b, the top of the adjacent cylinder bore 11b is covered by the lid 33. The top surface (deck surface) of the adjacent cylinder bore 11b can be hermetically closed. This can make the gas flow more appropriately. By actively forcing the air to flow toward the crankcase side, the adhesion of the thermal spray material can be prevented more reliably.

The holding part 34 is provided on the lid 33, With the holding part 34 being held, the gas blowing jig 30 is manipulated (or moved) in the vertical direction. This enables the gas blowing jig 30 to be inserted into the adjacent cylinder bore 11b or removed from the adjacent cylinder bore 11b.

A plurality of blowing openings 31 are formed on the outer circumferential surface of the main body 32. The plurality of blowing openings 31 are arranged at predetermined intervals on the outer circumferential surface of the main body 32. A gas is blown from the blowing openings 31 at a flow rate that is determined according to the gap between the outer circumferential surface of the main body 32 and the inner wall surface of the adjacent cylinder bore 11b. The blowing openings 31 are formed at the top (i.e., upper part) of the main body 32. That is, the blowing openings 31 are positioned immediately below the lid 33. This position can make the gas flow downward more appropriately.

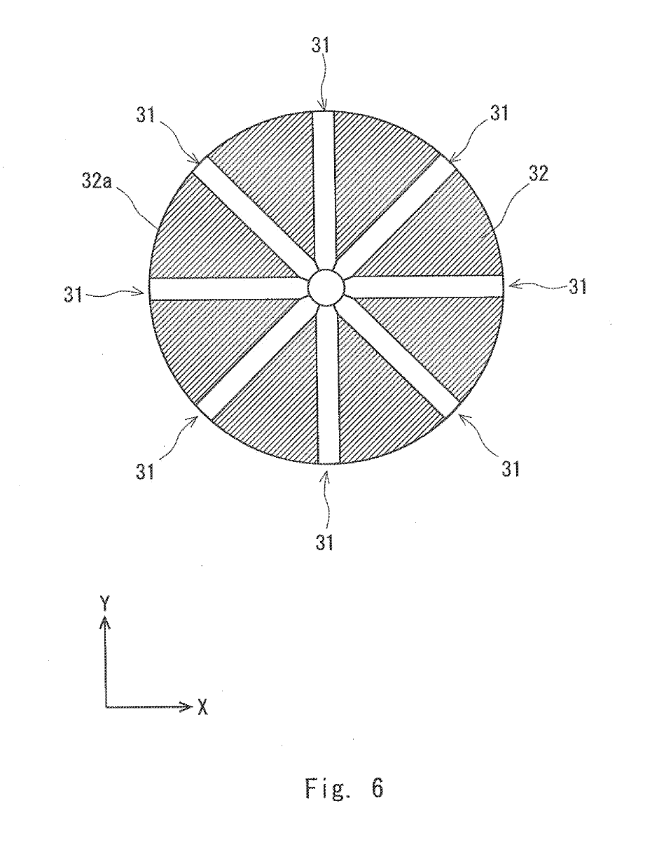

Inside the main body 32, the blowing openings 31 are formed in a radial shape as shown in FIG. 6. In FIG. 6, eight blowing openings 31 are formed on the outer circumferential surface 32a of the main body 32. The blowing openings 31 are formed in a radial shape. Therefore, the blowing openings 31 are arranged at regular intervals along the outer circumferential surface 32a of the main body 32. That is, the blowing openings 31 are arranged at angular intervals of 45°. Therefore, some of the blowing openings 31 are disposed in the area of the outer circumferential surface 32a of the main body 32 located on the side opposite to the side adjacent to the cylinder bore 11a. In an XY-plane, the plurality of blowing openings 31 is arranged in a symmetrical fashion. This arrangement can make the gas flow downward more appropriately. It is possible to make the air flow uniformly and hence prevent the adhesion of thermal spray droplets more effectively. Needless to say, the number of the blowing openings 31 is not limited to eight.

This configuration makes it possible to form an air shield throughout the entire gap between the gas blowing jig 30 and the adjacent cylinder bore 11b as shown in FIG. 7. That is, the air flows downward throughout the entire gap space between the gas blowing jig 30 and the adjacent cylinder bore 11b. By doing so, it is possible to prevent thermal spray droplets from adhering to the inner wall surface of the adjacent cylinder bore 11b through the breathing hole 12.

For example, when an air curtain is formed only in a part of an adjacent cylinder bore as in the case of Japanese Unexamined Patent Application Publication No. 2006-233960, the flow rate of the gas is non-uniform in the adjacent cylinder bore. Therefore, an upward air flow occurs in the adjacent cylinder bore. This causes the dragging of air, thus causing a possibility that thermal spray droplets could adhere to the stroke area where a piston slides through the connecting part (crankcase part) in the adjacent cylinder bore.

In contrast to this, the gas blowing jig 30 according to this exemplary embodiment makes the air flow downward throughout the entire gap space in the adjacent cylinder bore 11b. That is, an amount of air sufficient for preventing the adhesion of foreign substances flows in the Z-direction in the adjacent cylinder bore 11b. Therefore, it is possible to effectively prevent thermal spray droplets from adhering to the adjacent cylinder bore 11b through the breathing hole 12. Further, since the air uniformly flows downward, any upward dragging of air can be prevented. Even if thermal spray droplets enter inside the adjacent cylinder bore 11b through the breathing hole 12, they adhere to an area located below the breathing hole 12. Therefore, these thermal spray droplets adhere to the area located below the bottom of the stroke area where the piston slides in the adjacent cylinder bore 11b. Consequently, it is possible to prevent deterioration in the adhesive strength of the thermally-sprayed film and to prevent peeling of the thermally-sprayed film.

Since the plurality of blowing openings 31 are formed, the gas can be made to flow more appropriately. Specifically, the plurality of blowing openings 31 are arranged with intervals therebetween in the circumferential direction. This allows an appropriate amount of the gas to flow downward throughout the entire circumference. A downward gas flow is formed throughout the entire gap space between the gas blowing jig 30 and the adjacent cylinder bore 11b. This can prevent the adhesion of droplets more effectively.

Further, the only action that has to be performed is to insert the gas blowing jig 30 from the top mouth of the adjacent cylinder bore 11b. Therefore, the workability is excellent. As a result, thermal spraying can be performed with high productivity. Further, since the gas flows throughout the entire gap between the inner wall surface of the adjacent cylinder bore 11b and the gas blowing jig 30, the adhesion of thermal spray droplets to the gas blowing jig 30 can also be prevented. Therefore, the maintenance property can be improved. Further, since no thermal spray droplets adhere to the outer circumferential surface 32a of the main body 32, a uniform gas flow can be stably formed.

By performing thermal spraying by using the thermal spraying apparatus according to this exemplary embodiment, the adhesion of thermal spray droplets to the cylinder bores 11 can be effectively prevented. Therefore, the need for the masking (plugging up) for the breathing hole 12 can be eliminated. Alternatively, the need for preparing the crude material with no breathing hole 12 formed therein and forming a breathing hole 12 after thermal spraying is performed can be eliminated. As a result, the productivity can be improved.

As described above, the thermal spraying apparatus includes the thermal spraying gun 20 and the gas blowing jig 30. Note that in the case where thermal spraying is performed for the cylinder block 10 having four cylinder bores 11 shown in FIG. 1, two thermal spraying guns 20 and two gas blowing jig 30 may be prepared. For example, the thermal spraying guns 20 are inserted into the first and third cylinder bores 11 and the gas blowing jigs 30 are inserted into the second and fourth cylinder bores 11. Then, the inner wall surfaces of the first and third cylinder bores 11 are thermally-sprayed with a thermal spray material while a gas is blown inside the second and fourth cylinder bores 11. That is, when the odd-numbered cylinder bores 11 are thermally-sprayed, the gas blowing jigs 30 are inserted into the even-numbered cylinder bores 11.

After the thermal spraying on the inner wall surfaces of the first and third cylinder bores 11 is finished, the thermal spraying guns 20 and the gas blowing jigs 30 are removed from the cylinder bores 11. Then, the thermal spraying guns 20 are inserted into the second and fourth cylinder bores 11 and they are thermally-sprayed with the thermal spray material. Note that when the second and fourth cylinder bores 11 are thermally-sprayed with the thermal spray material, the gas blowing jigs 30 may not be used because the first and third cylinder bores 11 have already been thermally-sprayed. As described above, the thermal spraying guns 20 and gas blowing jigs 30 are inserted in alternate cylinder bores 11 of a plurality thereof arranged in a row. This enables an efficient thermal spraying process.

### Modified Examples

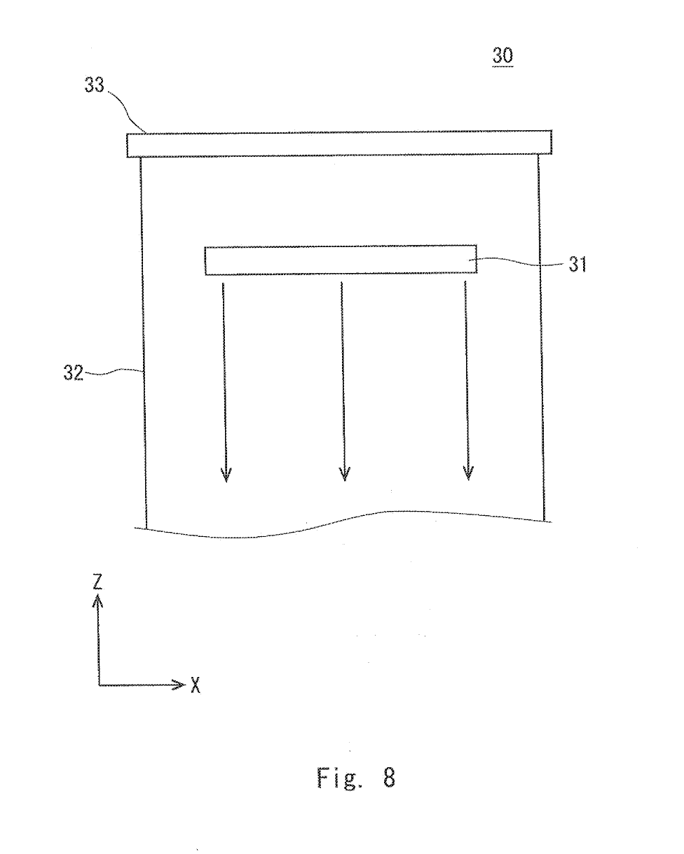

Modified examples of the gas blowing jig 30 are explained with reference to FIGS. 8 to 10. FIGS. 8 to 10 show modified examples of the arrangement of blowing openings 31. FIGS. 8 to 10 schematically show the structures of gas blowing jigs 30. Note that the structure of the gas blowing jig 30 except for the arrangement of the blowing openings 31 is similar to that of the first exemplary embodiment, and therefore its explanation is omitted as appropriate.

FIG. 8 is a side view schematically showing a gas blowing jig 30 according to a modified example 1. In FIG. 8, a blowing opening 31 has a slit shape. That is, the blowing opening 31 has its longitudinal direction perpendicular to the Z-direction and is formed along the outer circumferential surface. Even with this structure, a gas is blown downwardly from the top of the adjacent cylinder bore 11 throughout the entire inner wall surface thereof. Even in the structure shown in FIG. 8, a plurality of slit-shaped blowing openings 31 is preferably formed. Further, the plurality of slit-shaped blowing openings 31 are preferably arranged in a symmetrical fashion. This can make the gas flow uniform.

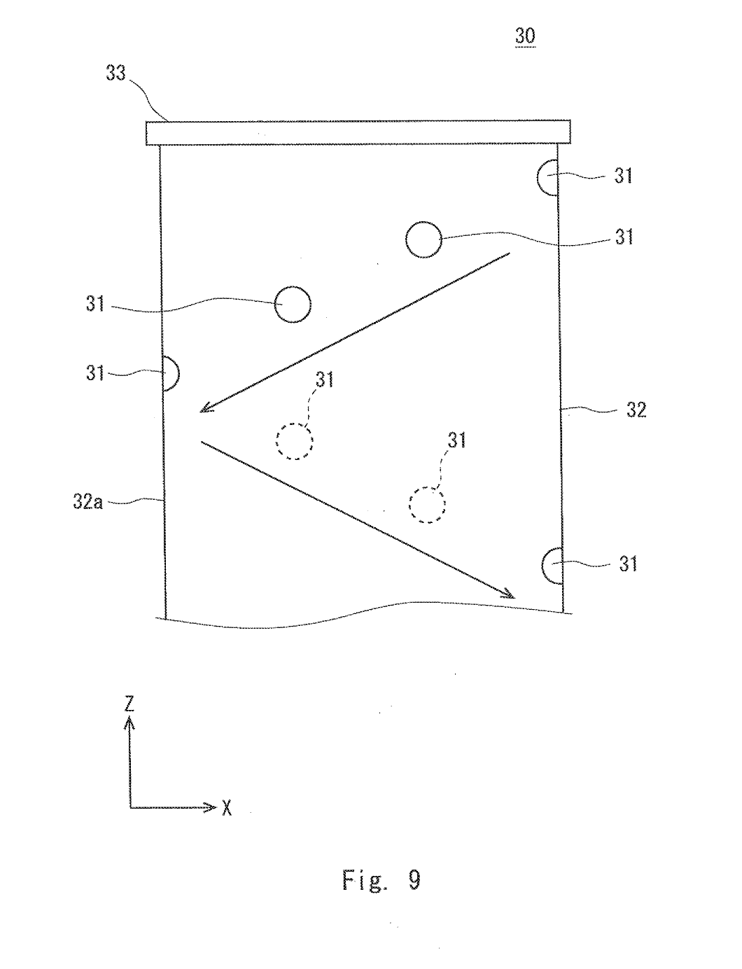

FIG. 9 is a side view schematically showing a gas blowing jig 30 according to a modified example 2. In FIG. 9, a plurality of blowing openings 31 are arranged in a helical fashion. Specifically, the plurality of blowing openings 31 are arranged at regular intervals along a helix on the outer circumferential surface of the main body 32. The positions of the plurality of blowing openings 31 differ from one another. Even with this structure, a gas is blown downwardly from the o of the adjacent cylinder bore 11 throughout the entire inner wall surface thereof.

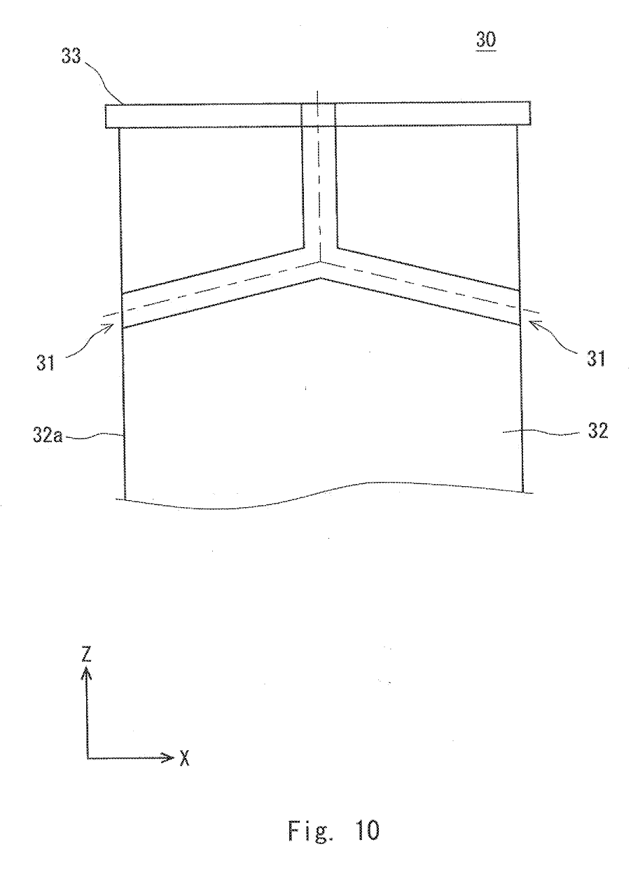

FIG. 10 is a cross section schematically showing a gas blowing jig 30 according to a modified example 3. In FIG. 10, each blowing opening 31 is formed in an obliquely downward direction. From the axis center of the main body 32 to its outer circumferential surface, the blowing openings 31 extend obliquely downward. Even with this structure, a gas is blown downwardly from the top of the adjacent cylinder bore 11 throughout the entire inner wall surface thereof.

Note that the present disclosure is not limited to the above-described first exemplary embodiment, and it can be modified as appropriate without departing from the sprit and scope of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A thermal spraying apparatus comprising:
a thermal spraying gun that sprays a thermal spray material on an inner wall surface of a cylinder bore of a cylinder block; and
a gas blowing jig inserted into an inside of an adjacent cylinder bore adjacent to the cylinder bore, a plurality of blowing openings being formed in the gas blowing jig, the blowing openings being configured so that a gas is blown therefrom and flows downward from a top of the adjacent cylinder bore throughout an entire inner wall surface thereof, wherein
the plurality of blowing openings are arranged with intervals therebetween along an outer circumferential surface of the gas blowing jig, the outer circumferential surface being opposed to the inner wall surface of the adjacent cylinder bore.

2. The thermal spraying apparatus according to claim 1, wherein the gas blowing jig comprises a lid that covers a top surface of the adjacent cylinder bore.

3. A thermal spraying method comprising:
inserting a thermal spraying gun into a cylinder bore of a cylinder block and inserting a gas blowing jig into an inside of an adjacent cylinder bore adjacent to the cylinder bore; and
spraying a thermal spray material on an inner wall surface of the cylinder bore by the thermal spraying gun while blowing a gas by the gas blowing jig so that the gas flows downward from a top of the adjacent cylinder bore throughout an entire inner wall surface thereof, wherein
a plurality of blowing openings are arranged with intervals therebetween along an outer circumferential surface of the gas blowing jig, the outer circumferential surface being opposed to the inner wall surface of the adjacent cylinder bore.

4. The thermal spraying method according to claim 3, wherein the gas blowing jig comprises a lid that covers a top surface of the adjacent cylinder bore.
